(19) United States
(12) Patent Application Publication
(10) Pub. No.: US 2008/0200202 A1
(43) Pub. Date: Aug. 21, 2008

(54) POWER CONTROL WITH LINK IMBALANCE ON DOWNLINK AND UPLINK

(75) Inventors: Juan Montojo, San Diego, CA (US); Ketan N. Patel, Ann Arbor, MI (US); Nathan Yee, Cupertino, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/029,383

(22) Filed: Feb. 11, 2008

Related U.S. Application Data
(60) Provisional application No. 60/889,691, filed on Feb. 13, 2007.

(51) Int. Cl. H04B 7/005

(52) U.S. Cl. 455/522

(57) ABSTRACT

Techniques for controlling transmit power are described. Due to link imbalance, a downlink (DL) serving cell may have the best downlink for a UE, and an uplink (UL) serving cell may have the best uplink for the UE. In one design of UL power control, the UE receives first and second UL TPC commands from the DL and UL serving cells, respectively, and adjusts its transmit power based on these UL TPC commands and in accordance with an OR-of-the-UPs rule. In one design of DL power control, the UE generates a DL TPC command based on received signal qualities of both the DL and UL serving cells. In another design, power control is performed independently for the DL and UL serving cells. The UE generates a separate DL TPC command for each cell, which adjusts its transmit power based on the DL TPC command for that cell.

### I. CLAIM OF PRIORITY UNDER 35 U.S.C. §119

The present Application for Patent claims priority to Provisional U.S. Application Ser. No. 60/889,691, entitled “POWER CONTROL IN WCDMA,” filed Feb. 13, 2007, assigned to the assignee hereof, and expressly incorporated herein by reference.

### BACKGROUND

I. Field

The present disclosure relates generally to communication, and more specifically to techniques for controlling transmit power for wireless communication.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In a wireless communication network, a Node B may communicate with a user equipment (UE) on the downlink and uplink. The downlink (or forward link) refers to the communication link from the Node B to the UE, and the uplink (or reverse link) refers to the communication link from the UE to the Node B. The Node B may transmit data and signaling to multiple UEs. It may be desirable to transmit to each UE using as little transmit power as possible while achieving the desired reliability for the downlink transmission to that UE. This may allow the Node B to serve more UEs. Multiple UEs may also transmit simultaneously to the Node B. It may be desirable for each UE to transmit using as little transmit power as possible while achieving the desired reliability for the uplink transmission to the Node B. This may reduce interference to other UEs and improve system performance.

### SUMMARY

Techniques for controlling transmit power on the downlink and uplink are described herein. Due to link imbalance, one cell may have the best downlink for a UE and may be selected as a downlink (DL) serving cell for the UE. Another cell may have the best uplink for the UE and may be selected as an uplink (UL) serving cell for the UE.

In an aspect, power control may be performed such that reliable radio links can be obtained for both the DL and UL serving cells. In one design of UL power control with link imbalance, the UE may receive a first UL transmit power control (TPC) command from the DL serving cell and may receive a second UL TPC command from the UL serving cell. The UE may adjust its transmit power based on the first and second UL TPC commands and in accordance with an OR-of-the-UPs rule. The UE may increase its transmit power if either UL TPC command directs an increase in transmit power and may decrease its transmit power if both UL TPC commands direct a decrease in transmit power. This may ensure that both the DL and UL serving cells can reliably receive signaling sent by the UE.

In one design of DL power control with link imbalance, the UE may determine the received signal quality of the DL serving cell and may also determine the received signal quality of the UL serving cell. The UE may generate a DL TPC command based on the received signal qualities of both the DL and UL serving cells. For example, the UE may generate a first TPC command based on the received signal quality of the DL serving cell and may generate a second TPC command based on the received signal quality of the UL serving cell. The UE may then generate the DL TPC command based on the first and second TPC commands and in accordance with the OR-of-the-UPs rule. The UE may send the DL TPC command to both the DL and UL serving cells. This may ensure that the UE can reliably receive signaling sent by the DL and UL serving cells.

In another aspect, power control may be performed independently for the DL and UL serving cells. For DL power control, the UE may generate a first DL TPC command for the DL serving cell based on the received signal quality for this cell. The UE may generate a second DL TPC command for the UL serving cell based on the received signal quality for this cell. The UE may send the first DL TPC command to the DL serving cell and may send the second DL TPC command to the UL serving cell. Each cell may adjust its transmit power for the UE based on the DL TPC command sent to that cell by the UE. For UL power control, the UE may adjust its transmit power for each cell based on an UL TPC command received from that cell.

In yet another aspect, the cell with the best uplink for the UE may be selected as both the DL and UL serving cells for the UE. This may ensure that signaling sent by the UE on the uplink can be reliably received by the selected serving cell.

In yet another aspect, different cells may use different modulation schemes to send UL TPC commands to the UE. One or more cells (e.g., the cell with the best uplink) may send UL TPC commands to the UE using binary phase shift keying (BPSK). Other cells may send UL TPC commands to the UE using on-off keying (OOK). These cells may send many UP commands to the UE. Each UP command may be sent using an off signal value, and hence no transmit power may be consumed in the common case when an UP command is sent.

Various aspects and features of the disclosure are described in further detail below.

### BRIEF DESCRIPTION OF THE DRAWINGS

FIG. 1 shows a wireless communication network.

FIGS. 2A, 2B and 2C show several downlink and uplink physical channels.

FIG. 3 shows communication between a UE and DL and UL serving cells.

FIG. 4 shows an UL power control mechanism suitable for link imbalance.

FIG. 5 shows a DL power control mechanism suitable for link imbalance.

FIG. 6 shows a process for performing UL power control with link imbalance.

FIG. 7 shows a process for performing DL power control with link imbalance.

FIG. 8 shows another process for performing DL power control with link imbalance.

FIG. 9 shows a process for independently performing DL and UL power control.

FIG. 10 shows separate DL and UL serving cells in a link imbalance scenario.

FIG. 11 shows a process for selecting a single serving cell with link imbalance.

FIG. 12 shows a process for receiving TPC commands sent with different modulation schemes.

FIG. 13 shows a block diagram of a UE, two Node Bs, and a network controller.

### DETAILED DESCRIPTION

The power control techniques described herein may be used for various wireless communication networks such as CDMA, TDMA, FDMA, OFDMA and SC-FDMA networks. The terms “network” and “system” are often used interchangeably. A CDMA network may implement a radio technology such as Universal Terrestrial Radio Access (UTRA), cdma2000, etc. UTRA includes Wideband-CDMA (W-CDMA) and other CDMA variants. cdma2000 covers IS-2000, IS-95, and IS-856 standards. A TDMA network may implement a radio technology such as Global System for Mobile Communications (GSM), etc. An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). E-UTRA is also known as 3GPP Long Term Evolution (LTE) and is an upcoming release of UMTS. UTRA, E-UTRA and GSM are described in documents from an organization named “3rd Generation Partnership Project” (3GPP). cdma2000 and UMB are described in documents from an organization named “3rd Generation Partnership Project 2” (3GPP2). These various radio technologies and standards are known in the art. For clarity, certain aspects of the techniques are described below for a UMTS network that utilizes W-CDMA, and UMTS terminology is used in much of the description below.

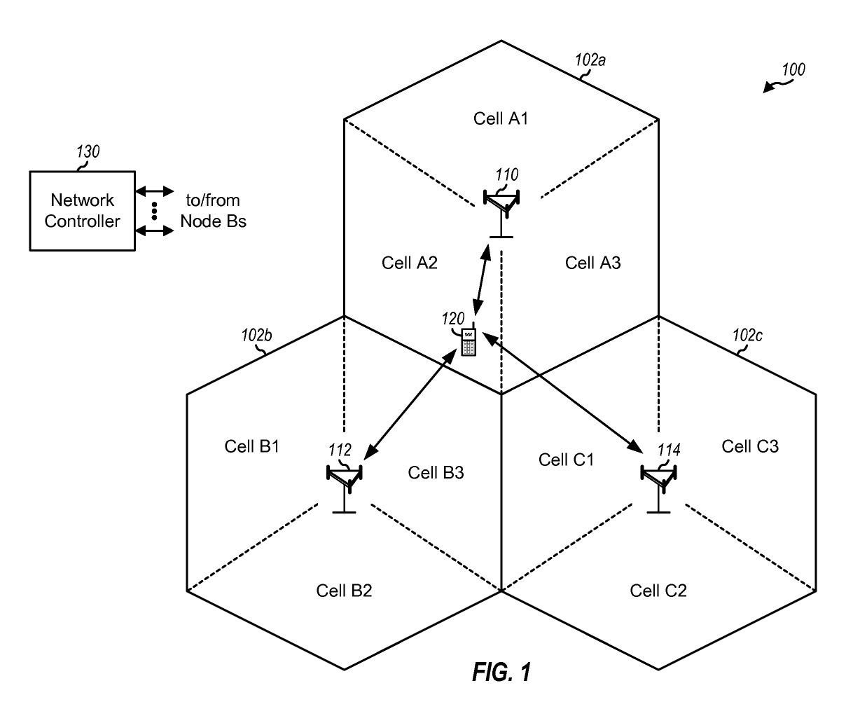

FIG. 1 shows a wireless communication network 100, which may also be referred to as a Universal Terrestrial Radio Access Network (UTRAN) in UMTS. Wireless network 100 may include many Node Bs that can support communication for many UEs. For simplicity, only three Node Bs 110, 112 and 114 and one UE 120 are shown in FIG. 1.

A Node B is generally a fixed station that communicates with the UEs and may also be referred to as an evolved Node B (eNode B), a base station, an access point, etc. Each Node B provides communication coverage for a particular geographic area 102 and supports communication for the UEs located within the coverage area. The coverage area of a Node B may be partitioned into multiple (e.g., three) smaller areas, and each smaller area may be served by a respective Node B subsystem. The term “cell” can refer to the smallest coverage area of a Node B and/or a Node B subsystem serving this coverage area, depending on the context in which the term is used. In the example shown in FIG. 1, Node B 110 serves cells A1, A2 and A3, Node B 112 serves cells B1, B2 and B3, and Node B 114 serves cells C1, C2 and C3.

In general, any number of UEs may be dispersed throughout the wireless network, and each UE may be stationary or mobile. A UE may also be referred to as a mobile station, a terminal, an access terminal, a subscriber unit, a station, etc. A UE may be a cellular phone, a personal digital assistant (PDA), a wireless device, a handheld device, a wireless modem, a modem card, a laptop computer, etc. A UE may communicate with one or more Node Bs on the downlink (DL) and/or uplink (UL) at any given moment. In the description herein, a DL serving cell is a cell designated to transmit data on the downlink to a UE, and an UL serving cell is a cell designated to receive data on the uplink from the UE. The DL serving cell and the UL serving cell may be the same cell in the common scenario in which the uplink and downlink are balanced. The DL serving cell and the UL serving cell may be different cells in a link imbalance scenario in which one cell has the best downlink for the UE and another cell has the best uplink for the UE.

Wireless network 100 may also include other network entities such as those described by 3GPP. A network controller 130 may couple to the Node Bs and provide coordination and control for these Node Bs. Network controller 130 may be a single network entity or a collection of network entities. For example, network controller 130 may comprise one or more Radio Network Controllers (RNCs). Network controller 130 may couple to a core network that may include network entities supporting various functions such as packet routing, user registration, mobility management, etc.

3GPP Release 5 and later supports High-Speed Downlink Packet Access (HSDPA). 3GPP Release 6 and later supports High-Speed Uplink Packet Access (HSUPA). HSDPA and HSUPA are sets of channels and procedures that enable high-speed packet data transmission on the downlink and uplink, respectively.

UMTS uses various physical channels to send data and signaling on the downlink and uplink. Signaling may also be referred to as control information, feedback information, overhead information, etc. Signaling may include any information that is not user data or pilot. The physical channels for each link are channelized with different channelization codes and are thus orthogonal to one another in the code domain. Table 1 lists some physical channels in 3GPP Release 6, including physical channels used for HSDPA and HSUPA.

TABLE 1

| | Channel | Channel Name | Description |
|---|---|---|---|
| | CPICH | Common Pilot Channel | Carry a common pilot for all |
| | (Downlink) | | UEs. |
| | P-CCPCH | Primary Common Control | Carry system information. |
| | (Downlink) | Physical Channel | |
| | F-DPCH | Fractional Dedicated | Carry UL TPC commands for |
| | (Downlink) | Physical Channel | different UEs. |
| | DPCCH | Dedicated Physical | Carry pilot and DL TPC |
| | (Uplink) | Control Channel | commands from a UE. |
| HSDPA | HS-SCCH | Shared Control Channel | Carry signaling for packets sent |
| | (Downlink) | for HS-DSCH | on the HS-PDSCH. |
| | HS-PDSCH | High Speed Physical | Carry packets sent on the |
| | (Downlink) | Downlink Shared Channel | downlink for different UEs. |
| | HS-DPCCH | Dedicated Physical Control | Carry ACK/NAK for packets |
| | (Uplink) | Channel for HS-DSCH | sent on the HS-PDSCH and CQI. |
| HSUPA | E-DPCCH | E-DCH Dedicated | Carry signaling for the |
| | (Uplink) | Physical Control Channel | E-DPDCH. |
| | E-DPDCH | E-DCH Dedicated | Carry packets sent on the uplink |
| | (Uplink) | Physical Data Channel | by the UE. |
| | E-HICH | E-DCH Hybrid ARQ | Carry ACK/NAK for packets |
| | (Downlink) | Indicator Channel | sent on the E-DPDCH. |
| | E-AGCH | E-DCH Absolute | Carry absolute grants of |
| | (Downlink) | Grant Channel | resources for the E-DPDCH. |
| | E-RGCH | E-DCH Relative | Carry relative grants of resources |
| | (Downlink) | Grant Channel | for the E-DPDCH. |

UE 120 may communicate with one or more cells on the downlink and uplink. DL power control may be used to adjust the transmit power of cells on the downlink. UL power control may be used to adjust the transmit power of UE 120 on the uplink. DL and UL power control may be performed as summarized in Table 2.

TABLE 2

| | Description |
|---|---|
| DL | DL TPC commands and CQI reports are generated by the UE |
| power | and sent to the cells. |
| control | Each cell may adjust its transmit power for the UE based on (i) |
| | an open loop setting of the transmit power and/or (ii) the DL |
| | TPC commands and/or CQI reports received from the UE. |
| UL | UL TPC commands are generated by each cell in the UE's active |
| power | set and sent to the UE. |
| control | The UE adjusts its transmit power based on the UL TPC |
| | commands received from the cells in its active set. |

A DL TPC command is a TPC command sent by a UE and may be used to adjust the transmit power of a cell for transmission on the downlink. An UL TPC command is a TPC command sent by a cell and may be used to adjust the transmit power of a UE for transmission on the uplink. A TPC command may be either (i) an UP command to direct an increase in transmit power, e.g., by a predetermined amount such as 0.5 or 1.0 dB, or (ii) a DOWN command to direct a decrease in transmit power, e.g., by the predetermined amount.

UE 120 may send DL TPC commands and pilot on the DPCCH. The transmit power of the DL TPC commands and the pilot may be adjusted to achieve the desired reliability for the DL TPC commands, e.g., to achieve a target error rate for the DL TPC commands. Each cell may send UL TPC commands for different UEs on the F-DPCH. The transmit power of the UL TPC commands may be adjusted to achieve the desired reliability for the UL TPC commands.

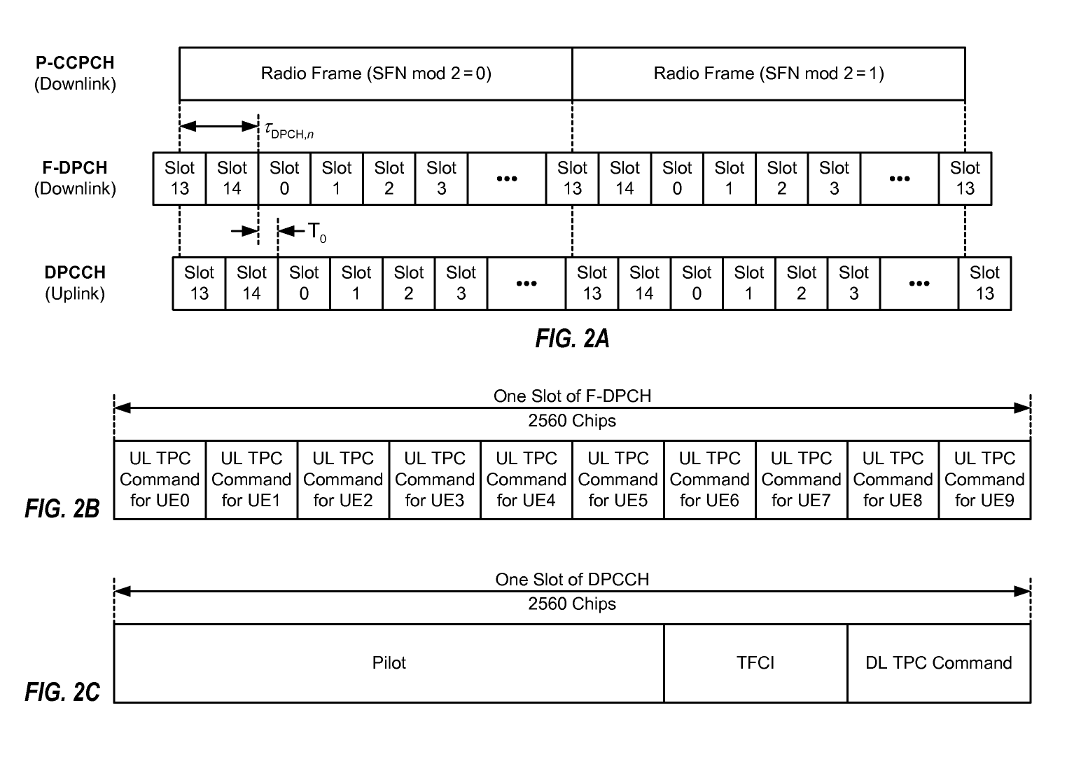

FIG. 2A shows a timing diagram of the P-CCPCH, F-DPCH and DPCCH. The timeline for transmission is divided into radio frames. Each radio frame has a duration of 10 milliseconds (ms) and is identified by a 12-bit system frame number (SFN). Each radio frame is partitioned into 15 slots, which are labeled as slot 0 through slot 14. Each slot has a duration of 0.667 ms and includes 2560 chips at 3.84 Mcps.

Each cell may transmit the P-CCPCH on the downlink. The P-CCPCH is used directly as timing reference for downlink physical channels and is used indirectly as timing reference for uplink physical channels. Each cell may also transmit the F-DPCH on the downlink. The F-DPCH may be delayed by τ_{DPCH,n} chips from the frame boundary of the P-CCPCH. UE 120 may transmit the DPCCH on the uplink. The DPCCH may be delayed by T₀=1024 chips from the frame boundary of the F-DPCH.

FIG. 2B shows one slot of the F-DPCH. The F-DPCH may carry up to ten UL TPC commands for up to ten different UEs at different time offsets in each slot. UE 120 may be assigned a specific time offset for the F-DPCH. UE 120 may then receive one UL TPC command at its assigned time offset in each slot.

FIG. 2C shows one slot of the DPCCH. The DPCCH may carry pilot, a transport format combination indicator (TFCI), and a DL TPC command in each slot. The duration of the three fields may be configurable.

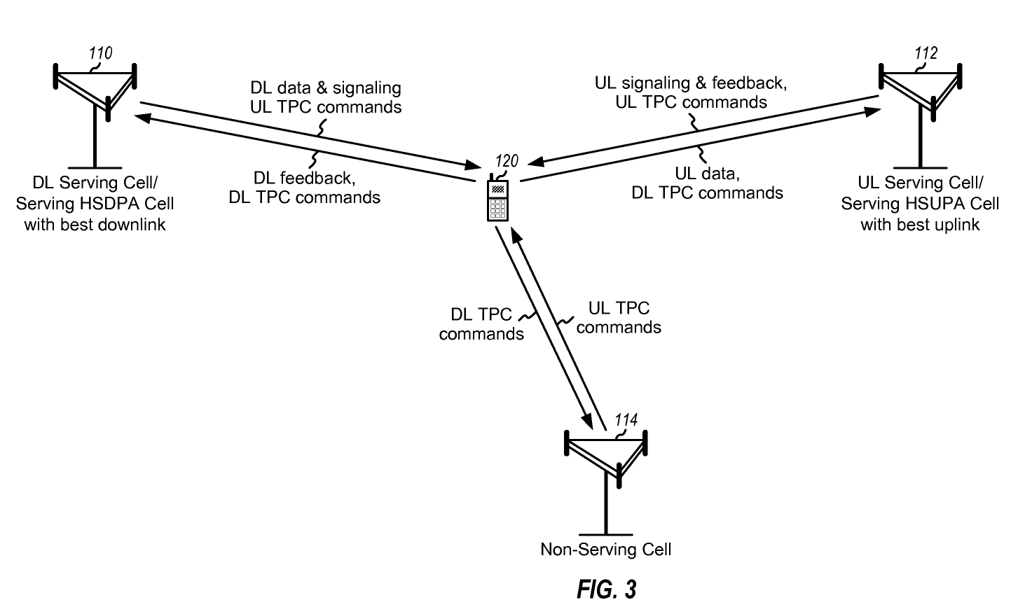

FIG. 3 shows communication between UE 120 and different cells with link imbalance. The UE may communicate with a DL serving cell, which may be referred to as a serving HSDPA cell, for the downlink. The UE may communicate with an UL serving cell, which may be referred to as a serving HSUPA cell, for the uplink. In the example shown in FIG. 3, the DL serving cell is part of Node B 110, and the UL serving cell is part of Node B 112. The UE may also have other cells in its active set, which may contain cells that can potentially serve the UE on the downlink and/or uplink. A non-serving cell is a cell in the active set that is not a serving cell.

The DL serving cell may be the cell in the active set with the best downlink for the UE. The UE may estimate signal-to-noise-and-interference ratios (SINRs) of different cells based on pilots transmitted by these cells. The cell with the best downlink may be determined based on the SINR estimates for these cells. The cell with the best downlink may also be determined in other manners.

The UL serving cell may be the cell in the active set with the best uplink for the UE. Each cell may estimate the SINR of the UE based on the pilot sent by the UE. The cell with the best uplink may be determined based on the SINR estimates obtained by different cells for the UE. The cell with the best uplink may also be determined in other manners, e.g., based on the number of DOWN commands sent by the cells to the UE.

For data transmission on the downlink, the DL serving cell may send signaling on the HS-SCCH and data on the HS-PDSCH to the UE. The UE may send feedback information (e.g., channel quality indicator (CQI) and ACK/NAK) on the HS-DPCCH to the DL serving cell. For data transmission on the uplink, the UE may send signaling on the E-DPCCH and data on the E-DPDCH to the UL serving cell. The UL serving cell may send feedback information (e.g., ACK/NAK) on the E-HICH and signaling on the E-AGCH and E-RGCH to the UE. The UE may thus exchange different signaling with different cells for data transmission on the downlink and uplink.

Data may be sent using hybrid automatic retransmission (HARQ). For HARQ, each packet may be sent in one or more transmissions until the packet is decoded correctly. Hence, power control for data may not be critical. Certain types of signaling (e.g., signaling sent on the HS-SCCH, E-HICH, E-AGCH and E-RGCH) may be sent by the cells at transmit power determined autonomously by these cells. This transmission strategy is referred to as open loop power control.

For DL power control, the UE may estimate the SINR of the DL serving cell, generate DL TPC commands based on the SINR estimate, and send the DL TPC commands to all cells in the UE's active set. Each cell may adjust its transmit power for the UE based on the DL TPC commands received from the UE. Since the DL TPC commands are generated based on the SINR of the DL serving cell, good reliability may be achieved for the downlink from the DL serving cell. However, if the DL serving cell has the best downlink, which is normally the case, then the downlink from the UL serving cell may not be sufficiently reliable when the UL serving cell adjusts its transmit power using the same DL TPC commands generated by the UE for the best downlink.

For UL power control, each cell may estimate the SINR of the UE, generate UL TPC commands based on the SINR estimate, and send the UL TPC commands to the UE. The UE may adjust its transmit power based on the UL TPC commands received from all cells in its active set. The UE may apply the OR-of-the-DOWN rule, as is normally done, and may decrease its transmit power if any cell sends a DOWN command. In this case, the transmit power of the UE may be adjusted predominantly by the UL TPC commands from the UL serving cell, which may have the best uplink for the UE and may then send the most DOWN commands. The uplink for the UE, including feedback information meant for the DL serving cell, may not be sufficiently reliable at the DL serving cell since the transmit power of the UE is adjusted to achieve the target reliability for the best uplink at the UL serving cell.

The UE may send signaling (e.g., feedback such as CQI and ACK/NAK on the HS-DPCCH) specifically to the DL serving cell at transmit power determined based on UL TPC commands received from all cells in the active set, in accordance with the OR-of-the-DOWNs rule. If there is link imbalance, then this signaling may be reliably received by the UL serving cell having the best uplink for the UE but may not be reliably received by the DL serving cell. The UL serving cell may not be interested in the signaling and may have no way of forwarding the signaling to the DL serving cell. Performance of downlink data transmission may be adversely impacted by the DL serving cell not reliably receiving the signaling. Similarly, the UE may send DL TPC commands on the uplink at transmit power determined based on the OR-of-the-DOWNs rule. These DL TPC commands may be reliable at the cell with the best uplink but may be unreliable at cells with weaker uplink. These cells may then send many UP commands on the downlink to the UE.

In general, performing power control for a given direction (e.g., downlink or uplink) based on the best radio link in that direction may provide good reliability for the cell with the best radio link but may provide unsatisfactory performance for all other cells. If a single serving cell has the best downlink and the best uplink for the UE, then power control may be performed to achieve good reliability for both the downlink and uplink for this cell. However, when there is link imbalance, different cells may have the best downlink and the best uplink for the UE. In this case, it may be desirable to have reliable downlink for both the DL and UL serving cells so that the UE can reliably receive signaling sent by these cells. It may also be desirable to have reliable uplink to both the DL and UL serving cells so that these cells can reliably receive signaling sent by the UE.

In an aspect, power control for each direction may be performed such that reliable radio links can be obtained for both the DL and UL serving cells. Power control may attempt to achieve the following:
Minimum transmit power on the uplink in order to exploit soft handoff operation,
Adequate transmit power for feedback channels on the downlink and uplink, and
Adequate transmit power for DL and UL TPC commands so that they can be used.
   The above goals as well as other goals may be achieved in different manners for the downlink and uplink, as described below.

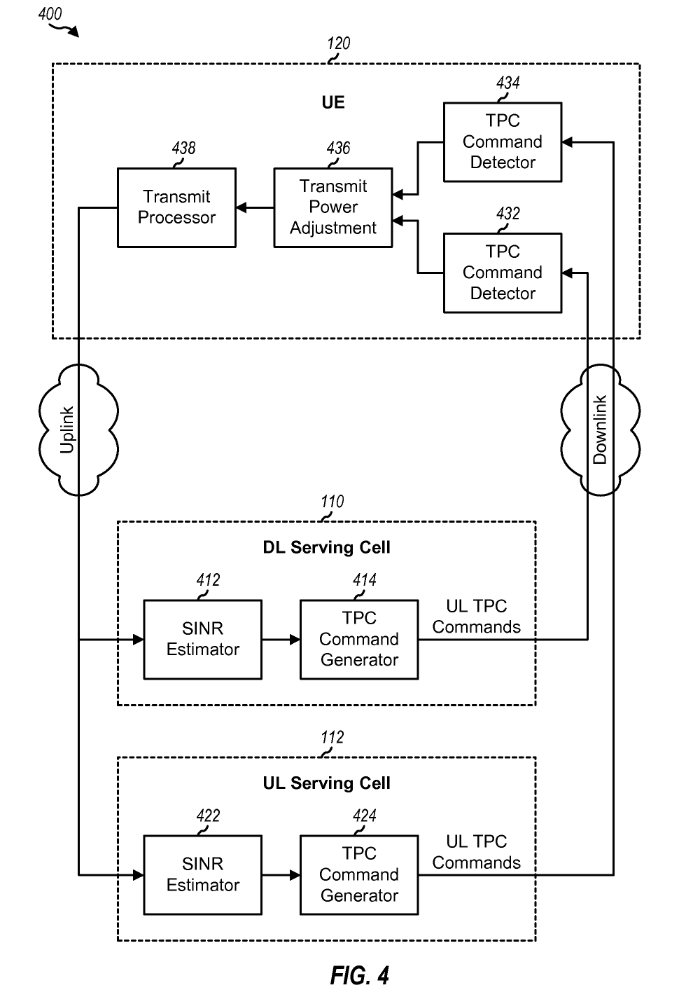

FIG. 4 shows a design of an UL power control mechanism 400 that can adjust the transmit power of the UE to achieve good reliability for the uplink for the DL and UL serving cells. The UE may transmit pilot and DL TPC commands on the DPCCH to the cells, e.g., as shown in FIG. 2C.

At the DL serving cell, an SINR estimator 412 may estimate the SINR of the pilot received from the UE and may provide an SNR estimate. A TPC command generator 414 may receive the SINR estimate and generate UL TPC commands for the UE, as follows:

If SINR_est<SINR_target, then UL TPC command=UP command, or

If SINR_est≧SINR_target, then UL TPC command=DOWN command, Eq (1)

where SINR_est is an SINR estimate for the UE, and SINR_target is a target SINR. The target SINR may be set to achieve the desired reliability for the uplink at the DL serving cell. The DL serving cell may send the UL TPC commands to the UE.

At the UL serving cell, an SINR estimator 422 may estimate the SINR of the pilot received from the UE. A TPC command generator 424 may receive an SINR estimate and generate UL TPC commands for the UE, as shown in equation (1). The target SINR used by the UL serving cell may or may not be equal to the target SINR used by the DL serving cell and may be set to achieve the desired reliability for the uplink at the UL serving cell. The UL serving cell may send the UL TPC commands to the UE.

At the UE, a TPC command detector 432 may receive and detect the UL TPC commands from the DL serving cell. Similarly, a TPC command detector 434 may receive and detect the UL TPC commands from the UL serving cell. A transmit power adjustment unit 436 may receive the UL TPC commands from the DL serving cell and the UL TPC commands from the UL serving cell. Unit 436 may combine the UL TPC commands from both cells and adjust the transmit power of the UE.

In one design, the UL TPC commands received from the DL and UL serving cells in each slot may be combined based on an OR-of-the-UPs rule, as follows:

Increase transmit power if either UL TPC command is an UP command, or

Decrease transmit power if both UL TPC commands are DOWN commands. Eq (2)

Unit 436 may provide the transmit power P_{UL} to use in each slot. A transmit processor 438 may generate and send data, pilot and signaling on the uplink based on the transmit power P_{UL} indicated by unit 436. The design in equation (2) may ensure that the transmission sent to each cell can be reliably received by that cell. For example, the design may ensure that the feedback information sent on the HS-DPCCH to the DL serving cell can be reliably received by this cell even if it does not have the best uplink for the UE.

In general, the UE may have any number of cells in its active set, and the DL serving cell may or may not be the UL serving cell. The UE may adjust its transmit power based on the UL TPC commands received from all cells in the active set, as follows:
1. If the DL serving cell is the same as the UL serving cell, then apply the OR-of-the-DOWNs rule to the UL TPC commands received from all cells in the active set.
2. If the DL serving cell is different from the UL serving cell, then apply the OR-of-the-UPs rule to:
   a. the UL TPC command received from the DL serving cell, and
   b. an UL TPC command obtained by applying the OR-of-the-DOWNs rule to the UL TPC commands received from all cells in the active set except for the DL serving cell.

In general, the OR-of-the-DOWNs rule and the OR-of-the-UPs rule may each be applied to any number of TPC commands. For OR-of-the-DOWNs of N TPC commands, where N>1, a DOWN command is obtained if any one of the N TPC commands is a DOWN command, and an UP command is obtained if all of the N TPC commands are UP commands. For OR-of-the-UPs of N TPC commands, an UP command is obtained if any one of the N TPC commands is an UP command, and a DOWN command is obtained if all of the N TPC commands are DOWN commands.

For rule 2 above, the DL serving cell with the weaker uplink may control the transmit power of the UE as a result of the OR-of-the-UPs rule. This may be desirable so that the signaling (e.g., CQI and ACK/NAK) sent by the UE to the DL serving cell can be reliably received by this cell. The UL TPC commands from the DL serving cell may be considered as CQI erasure indicators. In the link imbalance scenario, the UL TPC commands from the DL serving cell may be set to UP commands as needed in order to achieve a target CQI erasure rate. Based on the UL TPC commands, the UE may know whether or not the feedback information (e.g., the CQI and ACK/NAK) is erased at the DL serving cell, which may not have the best uplink for the UE. The UE may increase its transmit power based on the CQI erasure indicators so that the feedback information can be reliably received by the DL serving cell. This increase in transmit power for the DL serving cell may result in an increase in the transmit power of signaling sent on the E-DPCCH and data sent on the E-DPDCH to the UL serving cell. However, the higher transmit power for the E-DPDCH may reduce the number of transmissions/retransmissions.

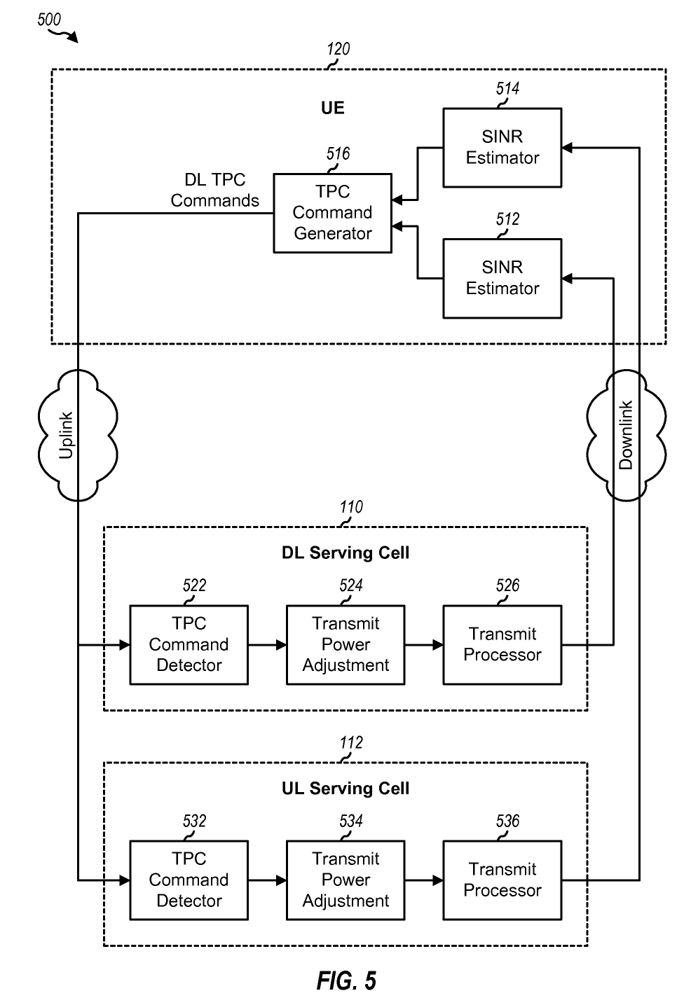

FIG. 5 shows a design of a DL power control mechanism 500 that can adjust the transmit power of the DL and UL serving cells to achieve good reliability for the downlink for the UE. At the UE, an SINR estimator 512 may estimate the SINR of the downlink for the DL serving cell and may provide an SNR estimate for this cell. This SINR estimate may be based on a downlink transmission that is power controlled. Each cell may send UL TPC commands on the F-DPCH to the UE at transmit power determined based on the DL TPC commands sent by the UE. The UE may thus estimate the SINR of each cell based on the UL TPC commands received from that cell. An SINR estimator 514 may similarly estimate the SINR of the downlink for the UL serving cell (e.g., based on the UL TPC commands received from this cell) and may provide an SNR estimate for this cell.

A TPC command generator 516 may receive the SINR estimate for the DL serving cell from unit 512 and the SINR estimate for the UL serving cell from unit 514. Generator 516 may generate DL TPC commands based on the SINR estimates for the DL and UL serving cells, as follows:

If (DLSC_SINR_est<SINR_target) OR (ULSC_SINR_est<SINR_target)

then DL TPC command=UP command,

else DL TPC command=DOWN command, Eq (3)

where DLSC_SINR_est is the SINR estimate for the DL serving cell, and

ULSC_SINR_est is the SINR estimate for the UL serving cell.

The target SINR may be set to achieve the desired reliability for the downlink transmissions from both the DL and UL serving cells to the UE, e.g., a target UL TPC command error rate or better for each of the DL and UL serving cells. In another design that may be equivalent to equation (3), the UE may generate a first DL TPC command for the DL serving cell based on the SINR estimate for this cell and may generate a second DL TPC command for the UL serving cell based on the SINR estimate for this cell. The UE may then apply the OR-of-the-UPs rule to the first and second DL TPC commands. The UE may generate an UP command if either DL TPC command is an UP command and may generate a DOWN command otherwise. In any case, the UE may send the DL TPC commands to the DL and UL serving cells.

At the DL serving cell, a TPC command detector 522 may receive and detect the DL TPC commands from the UE. A transmit power adjustment unit 524 may adjust the transmit power for the UE based on the DL TPC commands, as follows:

Increase transmit power if DL TPC command is UP command, or

Decrease transmit power if DL TPC command is DOWN command. Eq (4)

Unit 524 may provide the transmit power P_{DL1} to use for the UE in each slot. A transmit processor 526 may generate and send data, signaling, and UL TPC commands based on the transmit power P_{DL1} to the UE.

At the UL serving cell, a TPC command detector 532 may receive and detect the DL TPC commands from the UE. A transmit power adjustment unit 534 may adjust the transmit power for the UE based on the DL TPC commands, as shown in equation (4). Unit 534 may provide the transmit power PDL2 to use for the UE in each slot. A transmit processor 536 may generate and send data, signaling, and UL TPC commands based on the transmit power PDL2 to the UE.

In general, the UE may generate DL TPC commands to achieve the following:

1. Reliable UL TPC commands and signaling from the DL serving cell, and

2. Reliable UL TPC commands and signaling from the UL serving cell.

The design above may ensure that the UL TPC commands from both the DL and UL serving cells can be reliably received by the UE. This may then allow for proper adjustment of the transmit power of the UE to achieve good reliability for the DL TPC commands and signaling sent by the UE on the uplink. This design may also ensure that signaling sent on the downlink can be reliably received by the UE. For UMTS, the design may ensure reliable reception of the following at the UE:

1. HS-SCCH from the DL serving cell,

2. Downlink E-channels from the DL and UL serving cells, and

3. F-DPCH from the DL and UL serving cells.

The downlink E-channels (e.g., E-HICH, E-AGCH and E-RGCH) may be power controlled based on the DL TPC commands sent by the UE. For example, the transmit power of the downlink E-channels may be set at a fixed offset from the transmit power of the F-DPCH. If there is link imbalance and the DL serving cell has better downlink than the UL serving cell, then the transmit power of the HS-SCCH, the F-DPCH, the downlink E-channels from the DL serving cell may be higher than necessary. However, the design may ensure adequate transmit power for the channels from the UL serving cell.

As shown in FIGS. 4 and 5, reliable downlink and uplink for both the DL and UL serving cells may be achieved by changing the processing of the DL and UL TPC commands at the UE. Each cell may generate UL TPC commands in the normal manner and may also adjust its transmit power in the normal manner regardless of whether the DL and UL serving cells are the same cell or different cells.

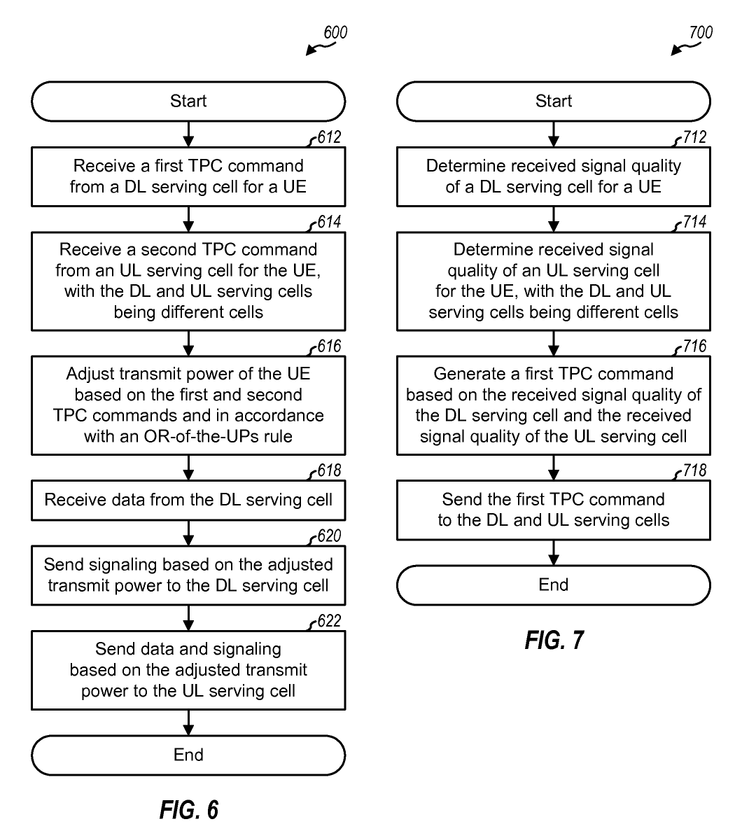

FIG. 6 shows a design of a process 600 for performing UL power control by the UE with link imbalance. The UE may receive a first TPC command from a DL serving cell for the UE (block 612). The UE may also receive a second TPC command from an UL serving cell for the UE, with the DL and UL serving cells being different cells (block 614). The DL serving cell may have the best downlink for the UE, and the UL serving cell may have the best uplink for the UE. The UE may adjust its transmit power based on the first and second TPC commands and in accordance with an OR-of-the-UPs rule (block 616). For block 616, the UE may increase its transmit power if either the first or second TPC command directs an increase in transmit power and may decrease its transmit power if the first and second TPC commands both direct a decrease in transmit power.

The UE may also receive at least one TPC command from at least one non-serving cell for the UE. The UE may obtain an intermediate TPC command by applying an OR-of-the-DOWNs rule on the second TPC command received from the UL serving cell and the at least one TPC command received from the at least one non-serving cell. The UE may then obtain a final TPC command by applying the OR-of-the-UPs rule on the first TPC command received from the DL serving cell and the intermediate TPC command. The UE may then adjust its transmit power based on the final TPC command.

The UE may receive data from the DL serving cell (block 618) and may send signaling based on the adjusted transmit power to the DL serving cell (block 620). The UE may also send data and signaling based on the adjusted transmit power to the UL serving cell (block 622). The UE may generate a third TPC command based on the received signal quality (e.g., the SINR) of the DL serving cell and the received signal quality of the UL serving cell. The UE may send the third TPC command based on the adjusted transmit power to the DL and UL serving cells.

FIG. 7 shows a design of a process 700 for performing DL power control by the UE with link imbalance. The UE may determine the received signal quality of a DL serving cell for the UE (block 712). The UE may also determine the received signal quality of an UL serving cell for the UE, with the DL and UL serving cells being different cells (block 714). The UE may generate a first TPC command based on the received signal quality of the DL serving cell and the received signal quality of the UL serving cell (block 716). The UE may send the first TPC command to the DL and UL serving cells (block 718).

For block 712, the UE may receive a second TPC command from the DL serving cell and may determine the received signal quality of the DL serving cell based on the second TPC command. For block 714, the UE may receive a third TPC command from the UL serving cell and may determine the received signal quality of the UL serving cell based on the third TPC command. The second and third TPC commands may be sent by the DL and UL serving cells, respectively, with power control. The UE may also determine the received signal quality of each cell based on some other transmission sent by that cell.

For block 716, the UE may set the first TPC command to an UP command if either the received signal quality of the DL serving cell is below a first threshold or the received signal quality of the UL serving cell is below a second threshold. The UE may set the first TPC command to a DOWN command otherwise. The first threshold may be determined based on a performance metric for the DL serving cell, and the second threshold may be determined based on a performance metric for the UL serving cell. The first threshold may or may not be equal to the second threshold. For block 716, the UE may generate a second TPC command based on the received signal quality of the DL serving cell and may generate a third TPC command based on the received signal quality of the UL serving cell. The UE may then generate the first TPC command based on the second and third TPC commands and in accordance with an OR-of-the-UPs rule.

In another design, the UE may generate DL TPC commands based only on SINR estimates for the DL serving cell and may send these DL TPC commands to the DL serving cell. The DL serving cell may adjust its transmit power for the UE based on the DL TPC commands received from the UE. Each remaining cell in the UE's active set, including the UL serving cell, may set the transmit power for transmission to the UE in an open loop fashion, without considering the DL TPC commands and/or CQI reports sent by the UE.

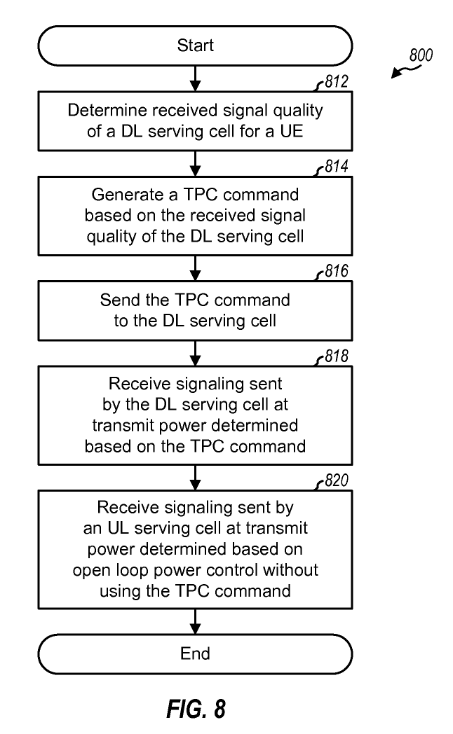

FIG. 8 shows a design of a process 800 for performing DL power control by the UE with link imbalance. The UE may determine the received signal quality of a DL serving cell for the UE (block 812). The UE may generate a TPC command based on the received signal quality of the DL serving cell (block 814). The UE may send the TPC command to the DL serving cell (block 816). The UE may receive signaling sent by the DL serving cell at transmit power determined based on the TPC command (block 818). The UE may receive signaling sent by an UL serving cell at transmit power determined based on open loop power control without using the TPC command (block 820).

In another aspect, power control may be performed independently for the DL and UL serving cells. For DL power control, the UE may generate a first set of DL TPC commands for the DL serving cell based on SINR estimates for this cell and may generate a second set of DL TPC commands for the UL serving cell based on SINR estimates for this cell. However, instead of combining the two sets of DL TPC commands as described above, the UE may send the first set of DL TPC commands on a first channel (e.g., an HS-UL-TPC channel) to the DL serving cell and may send the second set of DL TPC commands on a second channel (e.g., the DPCCH) to the UL serving cell. The DL serving cell may adjust its transmit power based on the first set of DL TPC commands received on the first channel. The UL serving cell may adjust its transmit power based on the second set of DL TPC commands received on the second channel.

For UL power control, the UE may adjust the transmit power of the first channel as well as other transmissions sent to the DL serving cell based on UL TPC commands received from this cell. The UE may adjust the transmit power of the second channel as well as other transmissions sent to the UL serving cell based on UL TPC commands received from this cell. The design thus separates the DL and UL power control for the DL serving cell from the DL and UL power control for the UL serving cell.

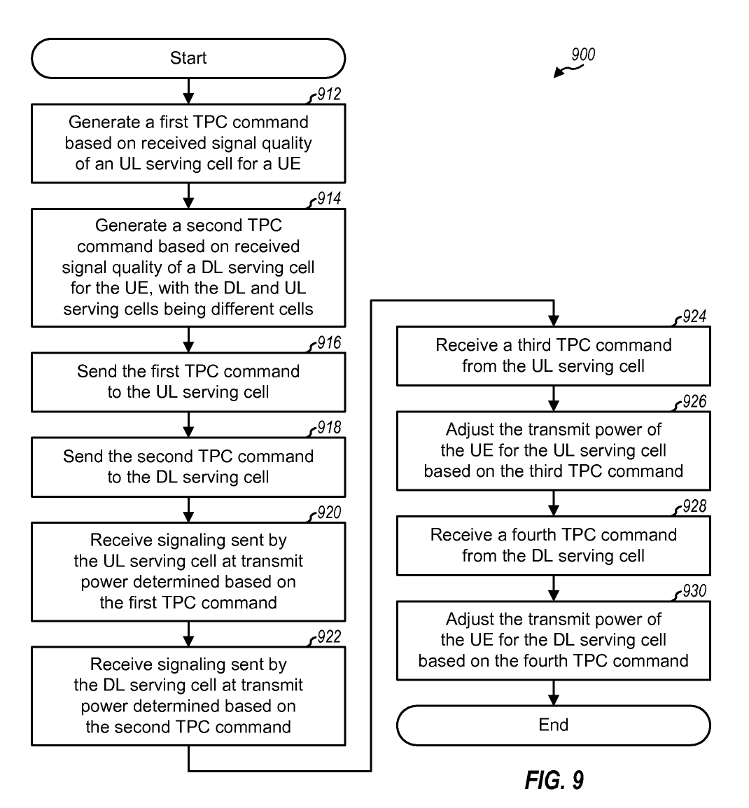

FIG. 9 shows a design of a process 900 for independently performing power control for the DL and UL serving cells with link imbalance. For DL power control, the UE may generate a first TPC command based on received signal quality of an UL serving cell for the UE (block 912). The UE may generate a second TPC command based on received signal quality of a DL serving cell for the UE, with the DL and UL serving cells being different cells (block 914). The UE may send the first TPC command to the UL serving cell (block 916) and may send the second TPC command to the DL serving cell (block 918). The UE may receive signaling (e.g., a TPC command) sent by the UL serving cell at transmit power determined based on the first TPC command (block 920). The UE may receive signaling sent by the DL serving cell at transmit power determined based on the second TPC command (block 922).

For UL power control, the UE may receive a third TPC command from the UL serving cell (block 924) and may adjust its transmit power for the UL serving cell based on the third TPC command (block 926). The UE may determine the received signal quality of the UL serving cell based on the third TPC command in block 912. The UE may send the first TPC command based on the adjusted transmit power for the UL serving cell in block 916. The UE may receive a fourth TPC command from the DL serving cell (block 928) and may adjust its transmit power for the DL serving cell based on the fourth TPC command (block 930). The UE may determine the received signal quality of the DL serving cell based on the fourth TPC command in block 914. The UE may send the second TPC command based on the adjusted transmit power for the DL serving cell in block 918.

In yet another aspect, a single cell may be selected as both the DL serving cell and the UL serving cell for the UE in a link imbalance scenario. The cell with the best uplink (instead of the cell with the best downlink) may be selected as the single serving cell for reasons described below.

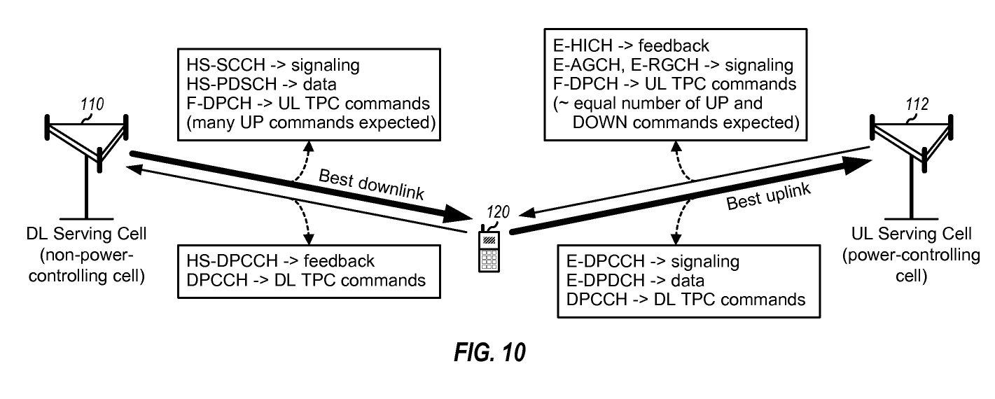

FIG. 10 shows separate DL and UL serving cells in a link imbalance scenario. The DL serving cell has the best downlink for the UE whereas the UL serving cell has the best uplink for the UE. For data transmission on the downlink with HSDPA, the DL serving cell may send signaling on the HS-SCCH and data on the HS-PDSCH to the UE, and the UE may send feedback information on the HS-DPCCH to the DL serving cell. For data transmission on the uplink with HSUPA, the UE may send signaling on the E-DPCCH and data on the E-DPDCH to the UL serving cell, and the UL serving cell may send feedback information on the E-HICH and signaling on the E-AGCH and E-RGCH to the UE.

For UL power control, each cell may generate UL TPC commands based on the pilot received from the UE and may send the UL TPC commands on the F-DPCH to the UE. Since the UL serving cell has the best uplink, the UL TPC commands from this cell may include approximately equal number of UP and DOWN commands. Since the DL serving cell has worse uplink, the UL TPC commands from this cell may include many UP commands. If the UE applies the OR-of-the-DOWNs rule, then the transmit power of the UE may be determined predominantly by the UL TPC commands from the UL serving cell, and many of the UP commands from the DL serving cell may be ignored. The UL serving cell may thus become the power-controlling cell for the UE and may make it difficult for the DL serving cell to reliably receive feedback information sent on the HS-DPCCH to the DL serving cell. Consequently, performance of data transmission on the downlink may degrade.

A single cell may be selected as both the DL and UL serving cells for the UE. If the cell with the best downlink is selected as the single serving cell, then the cell with the best uplink may power control down the transmit power of the UE, and the signaling sent by the UE to the cell with the best downlink may not be reliable. If the cell with the best uplink is selected as the single serving cell, then this cell will power control the transmit power of the UE to achieve reliable reception of the signaling sent by the UE to this cell. Thus, selecting the cell with the best uplink as the DL and UL serving cells for the UE may ensure reliable reception of signaling from the UE and good performance for data transmission on both the downlink and uplink.

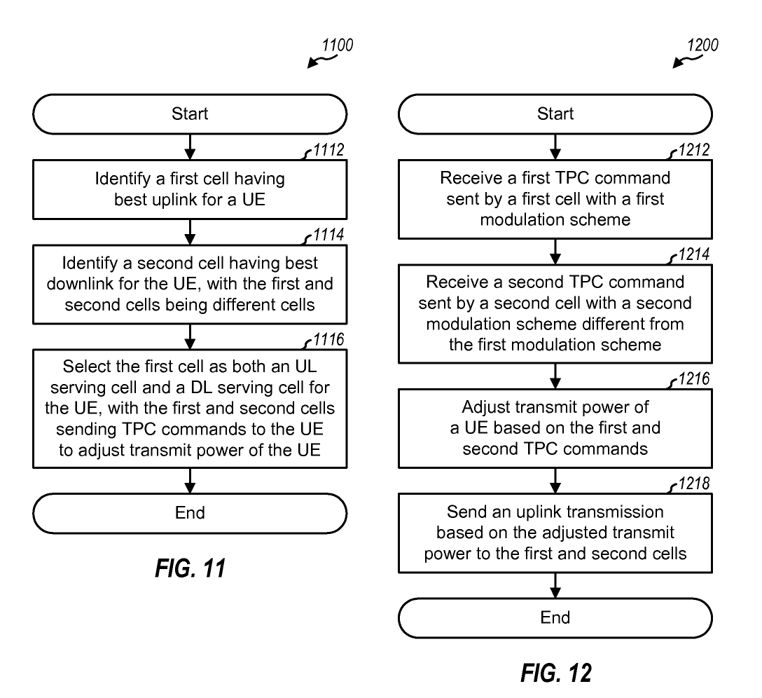

FIG. 11 shows a design of a process 1100 for selecting a single serving cell for the UE with link imbalance. Process 1100 may be performed by the UE, a Node B, the network controller, or some other entity. A first cell having the best uplink for the UE may be identified (block 1112). A second cell having the best downlink for the UE may be identified, with the first and second cells being different cells (block 1114). The first cell may be selected as both an UL serving cell and a DL serving cell for the UE (block 1116). The first and second cells may both send TPC commands to the UE to adjust transmit power of the UE.

For block 1112, the first cell may be identified as having the best uplink for the UE based on the TPC commands sent by the first and second cells to the UE, with the first cell sending more DOWN commands than the second cell. The first cell may also be identified as having the best uplink for the UE based on received signal quality of the UE at the first cell and received signal quality of the UE at the second cell.

For block 1114, the second cell may be identified as having the best downlink for the UE based on received signal quality of the first cell at the UE and received signal quality of the second cell at the UE. The second cell may also be identified as having the best downlink for the UE based on signaling sent by the UE.

In yet another aspect, different cells may use different modulation schemes to send UL TPC commands to the UE. TPC commands may be sent using BPSK. In this case, an UP command may be sent using one signal value (e.g., +V), and a DOWN command may be sent using another signal value (e.g., −V). The same amount of transmit power may be used to send either UP or DOWN command, which may improve the reliability of the TPC command. TPC commands may also be sent using OOK. In this case, an UP command may be sent using an off signal value (e.g., 0), and a DOWN command may be sent using an on signal value (e.g., +V). No transmit power is used to send an UP command, and transmit power is used to send a DOWN command.

As shown in FIG. 10, the cell with the best uplink may send approximately equal number of UP and DOWN commands whereas other cells with worse uplink may send many UP commands and few DOWN commands. In one design, the UL serving cell with the best uplink may send UL TPC commands using BPSK, and other cells in the active set may send UL TPC commands using OOK. This design may ensure good reliability for the UL TPC commands from the power-controlling cell while reducing transmit power of the other cells. In another design, the UL and DL serving cells may send UL TPC commands using BPSK, and non-serving cells in the active set may send UL TPC commands using OOK. In general, any cell in the active set may send UL TPC commands using BPSK, and remaining cells in the active set may send UL TPC commands using OOK.

The UE may have knowledge of which cell(s) are sending UL TPC commands using BPSK and which cell(s) are sending UL TPC commands using OOK. The UE may perform detection for the UL TPC commands received from each cell based on whether BPSK or OOK was used by that cell to send the UL TPC commands. In one design, the UE may use different detection thresholds for BPSK and OOK.

FIG. 12 shows a design of a process 1200 for receiving TPC commands sent with different modulation schemes. The UE may receive a first TPC command sent by a first cell with a first modulation scheme (block 1212). The UE may receive a second TPC command sent by a second cell with a second modulation scheme that is different from the first modulation scheme (block 1214). The first cell may be a serving cell for the UE, and the second cell may be a non-serving cell for the UE. The UE may adjust its transmit power based on the first and second TPC commands (block 1216). The UE may send an uplink transmission (e.g., pilot) based on the adjusted transmit power to the first and second cells (block 1218). The first and second cells may generate TPC commands for the UE based on the uplink transmission.

The first modulation scheme may be BPSK, and the second modulation scheme may be OOK. The second TPC command may be sent with an off value (or no transmit power) for an UP command and with an on value (or transmit power) for a DOWN command. The UE may receive approximately equal number of UP and DOWN commands from the first cell and may receive more UP commands than DOWN commands from the second cell. The UE may perform detection for the first TPC command based on at least one first threshold selected for the first modulation scheme. The UE may perform detection for the second TPC command based on at least one second threshold selected for the second modulation scheme.

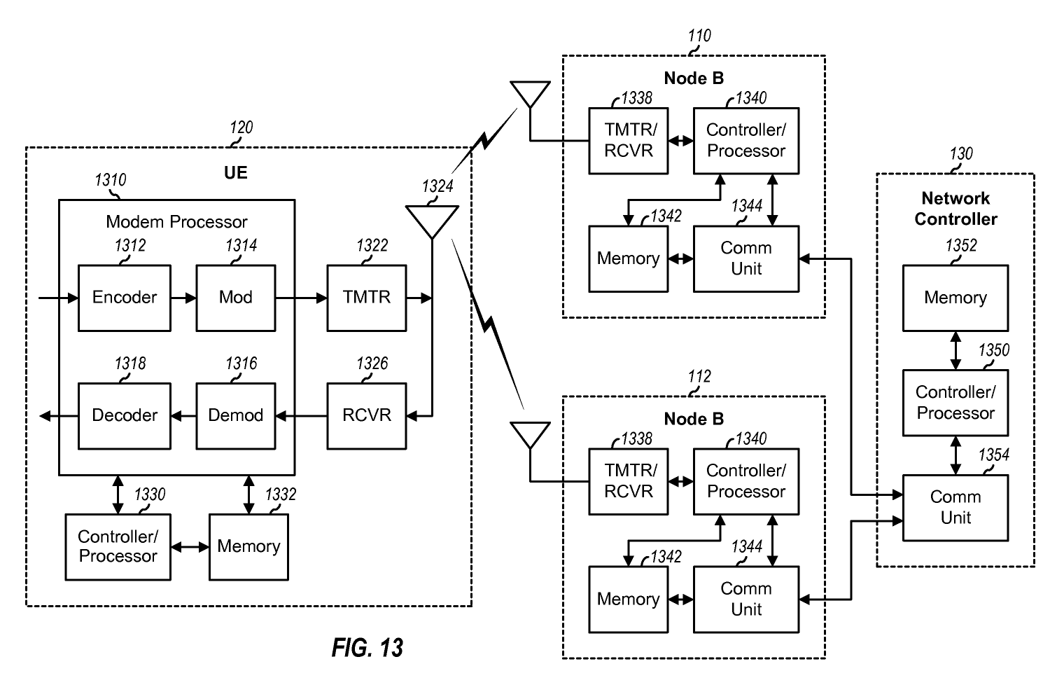

FIG. 13 shows a block diagram of a design of UE 120. On the uplink, an encoder 1312 may receive data and signaling (e.g., DL TPC commands) to be sent by UE 120 on the uplink. Encoder 1312 may process (e.g., format, encode, and interleave) the data and signaling. A modulator (Mod) 1314 may further process (e.g., modulate, channelize, and scramble) the encoded data and signaling and pilot and provide output chips. A transmitter (TMTR) 1322 may condition (e.g., convert to analog, filter, amplify, and frequency upconvert) the output chips and generate an uplink signal, which may be transmitted via an antenna 1324 to one or more Node Bs.

On the downlink, antenna 1324 may receive downlink signals transmitted by one or more Node Bs. A receiver (RCVR) 1326 may condition (e.g., filter, amplify, frequency downconvert, and digitize) the received signal from antenna 1324 and provide samples. A demodulator (Demod) 1316 may process (e.g., descramble, channelize, and demodulate) the samples and provide symbol estimates. A decoder 1318 may further process (e.g., deinterleave and decode) the symbol estimates and provide decoded data and signaling (e.g., UL TPC commands) sent to UE 120. Encoder 1312, modulator 1314, demodulator 1316, and decoder 1318 may be implemented by a modem processor 1310. These units may perform processing in accordance with the radio technology (e.g., W-CDMA) used by the wireless network.

A controller/processor 1330 may direct the operation of various units at UE 120. Controller/processor 1330 may implement process 600 in FIG. 6, process 700 in FIG. 7, process 800 in FIG. 8, process 900 in FIG. 9, process 1100 in FIG. 11, process 1200 in FIG. 12, and/or other processes for the techniques described herein. Controller/processor 1330 may also implement all or some of units 432 to 438 in FIG. 4 and all or some of units 512 to 516 in FIG. 5. Memory 1332 may store program codes and data for UE 120.

FIG. 13 also shows a block diagram of a design of Node Bs 110 and 112, which may be the DL and UL serving cells for UE 120. At each Node B, a transmitter/receiver 1338 may support radio communication with UE 120 and other UEs. A controller/processor 1340 may perform various functions for communication with the UEs. For uplink transmission, the uplink signal from UE 120 may be received and conditioned by receiver 1338 and further processed by a controller/processor 1340 to recover the uplink data and signaling (e.g., DL TPC commands) sent by the UE. For downlink transmission, data and signaling (e.g., UL TPC commands) may be processed by controller/processor 1340 and conditioned by transmitter 1338 to generate a downlink signal, which may be transmitted to the UEs. Controller/processor 1340 may implement processes applicable for a serving cell and complementary to the processes shown in FIGS. 6, 7, 8, 9, 11 and 12. Controller/processor 1340 may also implement one or both of units 412 and 414 in FIG. 4 and all or some of units 522 to 526 in FIG. 5. Memory (Mem) 1342 may store program codes and data for Node B 110 or 112. A communication (Comm) unit 1344 may support communication with network controller 130.

FIG. 13 also shows a block diagram of a design of network controller 130. At network controller 130, a controller/processor 1350 may perform various functions to support communication services for the UEs. Controller/processor 1350 may implement process 1100 in FIG. 11 and/or other processes for the techniques described herein. Memory 1352 may store program codes and data for network controller 130. A communication unit 1354 may support communication with Node Bs 110 and 112.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. An apparatus for wireless communication, comprising:
at least one processor configured to receive a first transmit power control (TPC) command from a downlink (DL) serving cell for a user equipment (UE), to receive a second TPC command from an uplink (UL) serving cell for the UE, the DL and UL serving cells being different cells, and to adjust transmit power of the UE based on the first and second TPC commands and in accordance with an OR-of-the-UPs rule; and
a memory coupled to the at least one processor.

2. The apparatus of claim 1, wherein the at least one processor is configured to increase the transmit power of the UE if either the first or second TPC command directs an increase in transmit power, and to decrease the transmit power of the UE if the first and second TPC commands both direct a decrease in transmit power.

3. The apparatus of claim 1, wherein the at least one processor is configured to receive at least one TPC command from at least one non-serving cell for the UE, to obtain a third TPC command by applying an OR-of-the-DOWNs rule on the second TPC command received from the UL serving cell and the at least one TPC command received from the at least one non-serving cell, to obtain a fourth TPC command by applying the OR-of-the-UPs rule on the first TPC command received from the DL serving cell and the third TPC command, and to adjust the transmit power of the UE based on the fourth TPC command.

4. The apparatus of claim 1, wherein the at least one processor is configured to receive data from the DL serving cell and to send feedback information based on the adjusted transmit power to the DL serving cell.

5. The apparatus of claim 1, wherein the at least one processor is configured to send data and signaling based on the adjusted transmit power to the UL serving cell.

6. The apparatus of claim 1, wherein the at least one processor is configured to generate a third TPC command based on received signal quality of the DL serving cell and received signal quality of the UL serving cell, and to send the third TPC command based on the adjusted transmit power to the DL and UL serving cells.

7. A method for wireless communication, comprising:
receiving a first transmit power control (TPC) command from a downlink (DL) serving cell for a user equipment (UE);
receiving a second TPC command from an uplink (UL) serving cell for the UE, the DL and UL serving cells being different cells; and
adjusting transmit power of the UE based on the first and second TPC commands and in accordance with an OR-of-the-UPs rule.

8. The method of claim 7, wherein the adjusting the transmit power of the UE comprises
increasing the transmit power of the UE if either the first or second TPC command directs an increase in transmit power, and
decreasing the transmit power of the UE if the first and second TPC commands both direct a decrease in transmit power.

9. The method of claim 7, further comprising:
receiving at least one TPC command from at least one non-serving cell for the UE, and wherein the adjusting the transmit power of the UE comprises
obtaining a third TPC command by applying an OR-of-the-DOWNs rule on the second TPC command received from the UL serving cell and the at least one TPC command received from the at least one non-serving cell,
obtaining a fourth TPC command by applying the OR-of-the-UPs rule on the first TPC command received from the DL serving cell and the third TPC command, and
adjusting the transmit power of the UE based on the fourth TPC command.

10. An apparatus for wireless communication, comprising:
means for receiving a first transmit power control (TPC) command from a downlink (DL) serving cell for a user equipment (UE);
means for receiving a second TPC command from an uplink (UL) serving cell for the UE, the DL and UL serving cells being different cells; and
means for adjusting transmit power of the UE based on the first and second TPC commands and in accordance with an OR-of-the-UPs rule.

11. The apparatus of claim 10, wherein the means for adjusting the transmit power of the UE comprises
means for increasing the transmit power of the UE if either the first or second TPC command directs an increase in transmit power, and means for decreasing the transmit power of the UE if the first and second TPC commands both direct a decrease in transmit power.

12. The apparatus of claim 10, further comprising:
means for receiving at least one TPC command from at least one non-serving cell for the UE, and wherein the means for adjusting the transmit power of the UE comprises
means for obtaining a third TPC command by applying an OR-of-the-DOWNs rule on the second TPC command received from the UL serving cell and the at least one TPC command received from the at least one non-serving cell,
means for obtaining a fourth TPC command by applying the OR-of-the-UPs rule on the first TPC command received from the DL serving cell and the third TPC command, and
means for adjusting the transmit power of the UE based on the fourth TPC command.

13. A computer program product, comprising:
a computer-readable medium comprising:
code for causing at least one computer to receive a first transmit power control (TPC) command from a downlink (DL) serving cell for a user equipment (UE);
code for causing the at least one computer to receive a second TPC command from an uplink (UL) serving cell for the UE, the DL and UL serving cells being different cells; and
code for causing the at least one computer to adjust transmit power of the UE based on the first and second TPC commands and in accordance with an OR-of-the-UPs rule.

14. The computer program product of claim 13, the computer-readable medium further comprising:
code for causing the at least one computer to increase the transmit power of the UE if either the first or second TPC command directs an increase in transmit power; and
code for causing the at least one computer to decrease the transmit power of the UE if the first and second TPC commands both direct a decrease in transmit power.

15. The computer program product of claim 13, the computer-readable medium further comprising:
code for causing the at least one computer to receive at least one TPC command from at least one non-serving cell for the UE;
code for causing the at least one computer to obtain a third TPC command by applying an OR-of-the-DOWNs rule on the second TPC command received from the UL serving cell and the at least one TPC command received from the at least one non-serving cell;
code for causing the at least one computer to obtain a fourth TPC command by applying the OR-of-the-UPs rule on the first TPC command received from the DL serving cell and the third TPC command; and
code for causing the at least one computer to adjust the transmit power of the UE based on the fourth TPC command.

16. An apparatus for wireless communication, comprising:
at least one processor configured to determine received signal quality of a downlink (DL) serving cell for a user equipment (UE), to determine received signal quality of an uplink (UL) serving cell for the UE, the DL and UL serving cells being different cells, to generate a first transmit power control (TPC) command based on the received signal quality of the DL serving cell and the received signal quality of the UL serving cell, and to send the first TPC command to the DL and UL serving cells; and
a memory coupled to the at least one processor.

17. The apparatus of claim 16, wherein the at least one processor is configured to generate a second TPC command based on the received signal quality of the DL serving cell, to generate a third TPC command based on the received signal quality of the UL serving cell, and to generate the first TPC command based on the second and third TPC commands and in accordance with an OR-of-the-UPs rule.

18. The apparatus of claim 16, wherein the at least one processor is configured to set the first TPC command to an UP command if either the received signal quality of the DL serving cell is below a first threshold or the received signal quality of the UL serving cell is below a second threshold, and to set the first TPC command to a DOWN command if both the received signal quality of the DL serving cell is above the first threshold and the received signal quality of the UL serving cell is above the second threshold.

19. The apparatus of claim 18, wherein the first threshold is determined based on a performance metric for the DL serving cell, and wherein the second threshold is determined based on a performance metric for the UL serving cell.

20. The apparatus of claim 16, wherein the at least one processor is configured to receive a second TPC command from the DL serving cell, to receive a third TPC command from the UL serving cell, to determine the received signal quality of the DL serving cell based on the second TPC command, and to determine the received signal quality of the UL serving cell based on the third TPC command.

21. The apparatus of claim 20, wherein the second and third TPC commands are sent by the DL and UL serving cells, respectively, with power control.

22. A method for wireless communication, comprising:
determining received signal quality of a downlink (DL) serving cell for a user equipment (UE);
determining received signal quality of an uplink (UL) serving cell for the UE, the DL and UL serving cells being different cells;
generating a first transmit power control (TPC) command based on the received signal quality of the DL serving cell and the received signal quality of the UL serving cell; and
sending the first TPC command to the DL and UL serving cells.

23. The method of claim 22, wherein the generating the first TPC command comprises
generating a second TPC command based on the received signal quality of the DL serving cell,
generating a third TPC command based on the received signal quality of the UL serving cell, and
generating the first TPC command based on the second and third TPC commands and in accordance with an OR-of-the-UPs rule.

24. The method of claim 22, further comprising:
receiving a second TPC command from the DL serving cell; and
receiving a third TPC command from the UL serving cell,
wherein the determining the received signal quality of the DL serving cell comprises determining the received signal quality of the DL serving cell based on the second TPC command, and
wherein the determining the received signal quality of the UL serving cell comprises determining the received signal quality of the UL serving cell based on the third TPC command.

25. An apparatus for wireless communication, comprising:
at least one processor configured to determine received signal quality of a downlink (DL) serving cell for a user equipment (UE), to generate a first transmit power control (TPC) command based on the received signal quality of the DL serving cell, to send the first TPC command to the DL serving cell, to receive signaling sent by the DL serving cell at transmit power determined based on the first TPC command, and to receive signaling sent by an uplink (UL) serving cell for the UE at transmit power determined based on open loop power control without using the first TPC command; and
a memory coupled to the at least one processor.

26. The apparatus of claim 25, wherein the at least one processor is configured to receive a second TPC command from the DL serving cell, to receive a third TPC command from the UL serving cell, and to adjust transmit power based on the second and third TPC commands.

27. The apparatus of claim 25, wherein the at least one processor is configured to adjust the transmit power of the UE based on the second and third TPC commands and in accordance with an OR-of-the-UPs rule.

28. A method for wireless communication, comprising:
determining received signal quality of a downlink (DL) serving cell for a user equipment (UE);
generating a first transmit power control (TPC) command based on the received signal quality of the DL serving cell;
sending the first TPC command to the DL serving cell;
receiving signaling sent by the DL serving cell at transmit power determined based on the first TPC command; and
receiving signaling sent by an uplink (UL) serving cell for the UE at transmit power determined based on open loop power control without using the first TPC command.

29. The method of claim 28, further comprising:
receiving a second TPC command from the DL serving cell;
receiving a third TPC command from the UL serving cell; and
adjusting transmit power of the UE based on the second and third TPC commands.

30. The method of claim 28, wherein the adjusting the transmit power comprises adjusting the transmit power of the UE based on the second and third TPC commands and in accordance with an OR-of-the-UPs rule.

31. An apparatus for wireless communication, comprising:
at least one processor configured to generate a first transmit power control (TPC) command based on received signal quality of an uplink (UL) serving cell for a user equipment (UE), to generate a second TPC command based on received signal quality of a downlink (DL) serving cell for the UE, the DL and UL serving cells being different cells, to send the first TPC command to the UL serving cell, and to send the second TPC command to the DL serving cell; and
a memory coupled to the at least one processor.

32. The apparatus of claim 31, wherein the at least one processor is configured to receive a third TPC command from the UL serving cell, to adjust transmit power of the UE for the UL serving cell based on the third TPC command, and to send the first TPC command based on the adjusted transmit power for the UL serving cell.

33. The apparatus of claim 32, wherein the at least one processor is configured to receive a fourth TPC command from the DL serving cell, to adjust transmit power of the UE for the DL serving cell based on the fourth TPC command, and to send the second TPC command based on the adjusted transmit power for the DL serving cell.

34. The apparatus of claim 33, wherein the at least one processor is configured to determine the received signal quality of the UL serving cell based on the third TPC command, and to determine the received signal quality of the DL serving cell based on the fourth TPC command.

35. The apparatus of claim 31, wherein the at least one processor is configured to receive signaling sent by the UL serving cell at transmit power determined based on the first TPC command, and to receive signaling sent by the DL serving cell at transmit power determined based on the second TPC command.

36. A method for wireless communication, comprising:
generating a first transmit power control (TPC) command based on received signal quality of an uplink (UL) serving cell for a user equipment (UE);
generating a second TPC command based on received signal quality of a downlink (DL) serving cell for the UE, the DL and UL serving cells being different cells;
sending the first TPC command to the UL serving cell; and
sending the second TPC command to the DL serving cell.

37. The method of claim 36, further comprising:
receiving a third TPC command from the UL serving cell; and
adjusting transmit power of the UE for the UL serving cell based on the third TPC command, and
wherein the sending the first TPC command comprises sending the first TPC command based on the adjusted transmit power for the UL serving cell.

38. The method of claim 37, further comprising:
receiving a fourth TPC command from the DL serving cell; and
adjusting transmit power of the UE for the DL serving cell based on the fourth TPC command, and
wherein the sending the second TPC command comprises sending the second TPC command based on the adjusted transmit power for the DL serving cell.

39. An apparatus for wireless communication, comprising:
at least one processor configured to identify a first cell having best uplink for a user equipment (UE), to identify a second cell having best downlink for the UE, the first and second cells being different cells, and to select the first cell as both an uplink (UL) serving cell and a downlink (DL) serving cell for the UE, the first and second cells sending transmit power control (TPC) commands to the UE to adjust transmit power of the UE; and
a memory coupled to the at least one processor.

40. The apparatus of claim 39, wherein the at least one processor is configured to identify the first cell as having the best uplink for the UE based on the TPC commands sent by the first and second cells to the UE, the first cell sending more DOWN commands than the second cell.

41. The apparatus of claim 39, wherein the at least one processor is configured to identify the first cell as having the best uplink for the UE based on received signal quality of the UE at the first cell and received signal quality of the UE at the second cell.

42. The apparatus of claim 39, wherein the at least one processor is configured to identify the second cell as having the best downlink for the UE based on received signal quality of the first cell at the UE and received signal quality of the second cell at the UE.

43. The apparatus of claim 39, wherein the at least one processor is configured to identify the second cell as having the best downlink for the UE based on signaling sent by the UE.

44. A method for wireless communication, comprising:
identifying a first cell having best uplink for a user equipment (UE);
identifying a second cell having best downlink for the UE, the first and second cells being different cells; and
selecting the first cell as both an uplink (UL) serving cell and a downlink (DL) serving cell for the UE, the first and second cells sending transmit power control (TPC) commands to the UE to adjust transmit power of the UE.

45. The method of claim 44, wherein the identifying the first cell comprises identifying the first cell as having the best uplink for the UE based on the TPC commands sent by the first and second cells to the UE, the first cell sending more DOWN commands than the second cell.

46. The method of claim 44, wherein the identifying the first cell comprises identifying the first cell as having the best uplink for the UE based on received signal quality of the UE at the first cell and received signal quality of the UE at the second cell.

47. An apparatus for wireless communication, comprising:
at least one processor configured to receive a first transmit power control (TPC) command sent by a first cell with a first modulation scheme, to receive a second TPC command sent by a second cell with a second modulation scheme different from the first modulation scheme, and to adjust transmit power of a user equipment (UE) based on the first and second TPC commands; and
a memory coupled to the at least one processor.

48. The apparatus of claim 47, wherein the first modulation scheme is binary phase shift keying (BPSK) and the second modulation scheme is on-off keying (OOK).

49. The apparatus of claim 48, wherein the second TPC command is sent with an off value for an UP command or an on value for a DOWN command.

50. The apparatus of claim 47, wherein the at least one processor is configured to receive approximately equal number of UP and DOWN commands from the first cell, and to receive more UP commands than DOWN commands from the second cell.

51. The apparatus of claim 47, wherein the first cell is a serving cell for the UE and the second cell is a non-serving cell for the UE.

52. The apparatus of claim 47, wherein the at least one processor is configured to perform detection for the first TPC command based on at least one first threshold selected for the first modulation scheme, and to perform detection for the second TPC command based on at least one second threshold selected for the second modulation scheme.

53. The apparatus of claim 47, wherein the at least one processor is configured to send an uplink transmission based on the adjusted transmit power to the first and second cells, and wherein the first and second TPC commands are determined by the first and second cells, respectively, based on the uplink transmission.

54. A method for wireless communication, comprising:
receiving a first transmit power control (TPC) command sent by a first cell with a first modulation scheme;
receiving a second TPC command sent by a second cell with a second modulation scheme different from the first modulation scheme; and
adjusting transmit power of a user equipment (UE) based on the first and second TPC commands.

55. The method of claim 54, wherein the first modulation scheme is binary phase shift keying (BPSK) and the second modulation scheme is on-off keying (OOK), and wherein the second TPC command is sent with an off value for an UP command or an on value for a DOWN command.

56. The method of claim 54, further comprising:
performing detection for the first TPC command based on at least one first threshold selected for the first modulation scheme; and
performing detection for the second TPC command based on at least one second threshold selected for the second modulation scheme.
